(19) United States
(12) Patent Application Publication
(10) Pub. No.: US 2012/0303390 A1
(43) Pub. Date: Nov. 29, 2012

(54) SYSTEM AND METHOD FOR MAINTENANCE AND PERPETUATION OF A DEDICATED DATA BODY

(76) Inventors: Alan Brook, Cupertino, CA (US); Roy P. Sussman, Coogee (AU)

(21) Appl. No.: 13/117,737

(22) Filed: May 27, 2011

(51) Int. Cl. G06Q 40/00

(52) U.S. Cl. 705/4; 705/39

(57) ABSTRACT

One example embodiment relates to a method comprising creating a legal entity, creating a fund, and establishing an insurance policy. The legal entity is associated with an original owner, a dedicated data body and data services for the dedicated data body. The fund is associated with the legal entity and which is managed by a fund manager. The insurance policy is associated with the legal entity and is issued by an insurance provider. Another example embodiment relates to a method comprising creating a legal entity that is associated with an original owner, a dedicated data body and data services for the dedicated data body. The method further comprises establishing an insurance policy, associated with the legal entity, which is issued by an insurance provider. Other embodiments also exist.

### BACKGROUND

In recent years, the amount of data that people generate and store has been increasing dramatically. Familiar software applications that help organize and optimize personal and professional productivity are rapidly becoming inseparable parts of many people's lives. The omnipresence of powerful mobile devices is accelerating the use and personal dependence on this technology. Likewise, the amount of data that third parties (e.g., businesses, governments, etc.) generate and store regarding specific persons has similarly increased. In many jurisdictions ‘Freedom of Information’ legislation is increasing the access of individuals to this third-part data. Examples of such self-generated and third-party generated data include images, videos (e.g., social, work, surveillance, etc.), voice recordings (e.g., personal conversations, recorded conversations with institutions, etc.), text (e.g., email, documents, social networking interactions), personal websites (e.g., blogs), medical records, government, education and legal records, retail history, and so on.

Many people, for various reasons, require a large part of their personal data to be retained for long periods—lifelong and often beyond. An ever-increasing part of personal data is being natively created on-line, and internet or cloud based storage services are being adopted by large numbers of people. Many new applications are dedicated to the processing of the data to facilitate efficient subsequent search and data mining with many useful results such as long-term recollection of information and events. Additionally, there is a dramatic growth in applications designed for legacy, memorial, genealogy, and other typically, afterlife uses. Many people, organizations, and cultures desire that these kinds of data be indefinitely accessible.

A number of large-scale projects and solutions for the indefinite (perpetual) preservation of data exist. These are mainly for public, governmental, or institutional data such as those of the U.S. Library of Congress and other national and international governmental and NGO organizations. Due to the exponential growth and value of personal data, solutions that are robust, convenient, and cost effective are also desirable for the long-term retention and maintenance of such personal data and other social entity related information.

### SUMMARY

One example embodiment of the invention relates to a method comprising creating a legal entity, creating a fund, and establishing an insurance policy. The legal entity is associated with an original owner, a dedicated data body and data services for the dedicated data body. The fund is associated with the legal entity and which is managed by a fund manager. The insurance policy is associated with the legal entity and is issued by an insurance provider.

Another example embodiment of the invention relates to a method comprising creating a legal entity that is associated with an original owner, a dedicated data body and data services for the dedicated data body. The method further comprises establishing an insurance policy, associated with the legal entity, which is issued by an insurance provider.

Another example embodiment of the invention relates to a method performed by a virtual life manager. The method is performed in a system comprising a dedicated data body stored in computer-readable media, data services providers that service the dedicated data body, and a virtual life manager that engages and oversees the services providers. The method comprises receiving payments from the data owner; deducting, from the payments, fees for services of the virtual life manager; and making repeated payments to the data services providers. The payments to the data services providers are at least partially for compensating the data services providers for storing and maintaining the dedicated data body, for ensuring that the data body remains continuously accessible by computing devices over time, and for providing services and applications for the growth and use of the data body. The dedicated data body comprises data that is dedicated to a specific social or commercial entity. The dedicated data body is stored in machine-readable storage media and being accessible by computing devices via global networks.

### BRIEF DESCRIPTION OF THE DRAWINGS

FIG. 1 shows a data input, output and data processing environment for a personal virtual presence system.

FIG. 2 shows an aspect of implementation of a data services system of FIG. 1 provided by services providers in greater detail.

FIGS. 3A-4B show another embodiment of a perpetual virtual presence system which also includes an insurance provider, a fund manager and a guardian.

FIG. 5 shows an arrangement in which a data body and services of FIGS. 1-4B is used to provide personal assistant functionality.

FIG. 6 shows an arrangement in which a data body and services of FIGS. 1-4B is used to provide human simulation functionality.

### DETAILED DESCRIPTION OF THE PREFERRED EMBODIMENTS

Referring now to the Figures, systems and methods are provided that store data regarding an individual or other entity for long periods of time. In an example embodiment, the system is constructed so as to be capable of storing the data beyond the lifetime of the individual. For example, the system may be constructed such that there is no predetermined limit on the amount of time for which data may be stored. In an example embodiment, the system allows people to preserve personal and collective memories and create legacies that may potentially endure for long periods (potentially, in perpetuity). Herein, the term “perpetuity” refers to a time period that does not have a predetermined endpoint. Likewise, an entity that is described as being “perpetual” refers to an entity that exists for a time period that does not have a predetermined endpoint. Hence, herein, such an entity may be “perpetual” even though it ultimately only turns out to be in existence for a finite number of years. Perpetual data storage (e.g., even if the storage is only for the lifetime of an individual) would be considered a useful result by many individuals. In example embodiments, the data is owned by a person (hereinafter, “owner”) and is portable such that it can be moved from one data services provider to another. The data may also be owned by other entities, such as a legal entity created at least in part for this purpose. The legal entity may in turn be owned by a person or another entity. In example embodiments, the data storage is configured to be for an ongoing, unlimited period of time and, from the perspective of the owner, is not subject to cancellation, revocation, or termination.

The system described herein is used to store a dedicated data body. Herein, for purposes of providing an example, it is assumed that the dedicated data body comprises data relating to a specific individual. In this case, it may be called a personal virtual presence (herein, “PVP”). As will be appreciated, however, the dedicated data body may relate to other entities, such as religious or cultural organizations, sports teams, businesses, music groups, families, pets, other social entities, and so on. The data body is “dedicated” in that it is dedicated to one particular entity as opposed to entities of that type in general. For example, in an embodiment where the dedicated data body relates to a specific person, it is dedicated in that it relates to that specific person as opposed to larger segments of the human population or the human population as a whole. As will also be appreciated, multiple permutations of data bodies may exist for each of such entities. For example, a politician may have a data body that reflects her political career and vision and a separate data body that reflects her personal and family life.

In example embodiments, in order to facilitate perpetual data storage, the systems and methods described herein include features to enhance long term stability, robustness, and self-healing properties. The systems and methods may be constructed with the built-in assumption that components will need to be replaced over time due to, e.g., changes in technology, component failures, changing conditions, and so on. Therefore, the design may be modular to facilitate the replacement of such components. For example, the data may be stored in open data formats and, as previously indicated, the data may be owned by the owner and portable such that it can be moved from one data services provider to another. The ability to adapt to changing conditions makes the system future ready. Additionally, the systems and methods may include feedback and monitoring mechanisms to ensure long term viability. The feedback and monitoring mechanisms in combination with the portability of data and replaceability of components help avoid a single point of failure. The systems and methods may be constructed so as to promote alignment of interests of individuals, commercial entities and other organizations with the dedicated data body, which also promotes long term stability, robustness, and self-healing properties.

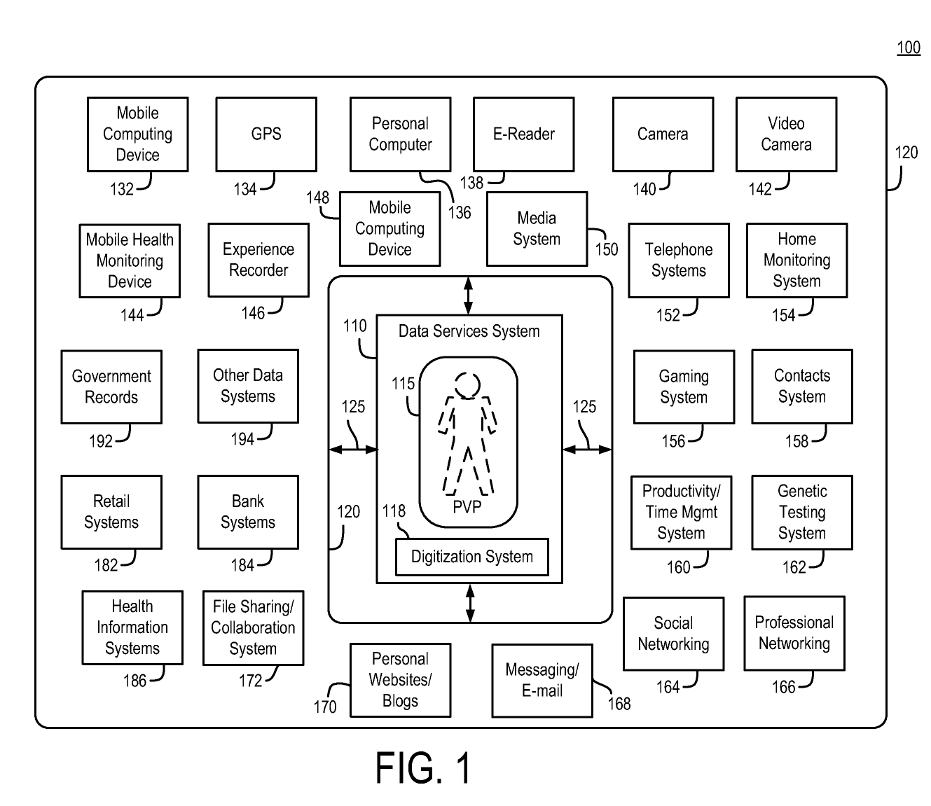

Referring to FIG. 1, a data input, output and data processing environment for a personal virtual presence 100 is shown. Specifically, FIG. 1 shows a data services system 110 that develops and maintains a data body 115. The data body 115 may be developed using data collected from data devices 120. The data services system 110 may, for example, comprise computers (e.g., networked servers). Other computing arrangements are also possible. In one embodiment, the data services system 110 is at least partially implemented in a cloud computing arrangement. The data services system 110 may be connected to data devices 120 which may include input devices (e.g., devices capable of collecting and processing data and providing the data to the data services system 110 for storage) and output devices (e.g., devices capable of receiving data from the data services system 110 and using the data to provide output to a user or as an input to other applications). As will be appreciated, many devices may operate as both input devices and output devices. As data is collected, it is processed. For example, metadata may be generated and stored with the data, e.g., to provide additional context to the data such as location data, connections to events, and so on. For example, all of the data from the devices 120 may be tagged with the time and location (e.g., GPS coordinates) of creation as it is collected and stored so that it may be associated with a specific point in time and place in the owner's life. Such tagging may be used to correlate data from disparate sources and create additional metadata. For example, data from the owner's personal or productivity organizer software application can be used to create metadata indicating the activity of the person at the time of the creation.

The data services system 110 may be connected to devices 120 via network(s) 125 which may, for example, comprise a global computing network (e.g., the Internet), telecommunications network, and/or other networks, depending, e.g., on the particular device. In an example embodiment, data may be continuously streamed by the devices 120 to the data services system 110. As another example, data may be periodically uploaded by the devices 120 to the system 100 (e.g., as part of an automated background processing operation). As another example, data may be continuously recorded by the devices 120 for later manual uploading to the data services system 110. As will be appreciated, different arrangements may be used for different devices 120.

The devices 120 may, for example, comprise a wide array of devices used by the owner as part of his or her everyday life. The data from the devices 120 may be used to record and store detailed impressions of the moments and events in the owner's life. Hence, using data stored from the devices 120, detailed aspects of the owner's past existence may be recalled far into the future. In an example embodiment, the data body 115 may comprise the entire data set generated by the owner's existence and may be considered to be the machine equivalent of the owner's long-term memory. As will be appreciated, the number and types of devices 120 used may vary according to implementation and from owner to owner. Collecting more data may result in a more robust data body 115 that provides more detailed impressions/memories of the moments and events in the owner's life. Collecting less data may result in a data body 115 that, though less detailed, remains useful and is less costly to maintain over time.

In the example of FIG. 1, the data body 115 comprises data relating to the owner, e.g., a specific individual. The data is collected from various computing devices and systems, including personal electronic devices, home electronics systems, social media systems, business systems, and other data systems. For example, the personal electronic devices may include mobile computing device 132, GPS devices 134, personal computers 136, e-readers 138, cameras 140, video cameras 142, mobile health monitoring devices 144, experience recorders 146, other mobile computing devices 148. The mobile computing device 132 may, for example, be a smartphone that captures telephone conversations of the owner. A speech recognition module may be used to convert voice to text, such that the text of conversations had by the owner may be included as part of the stored data. The speech recognition module may be implemented as part of the mobile computing device 132 or may be implemented at the data services system 110 (e.g., as part of digitization system 118). The speech recognition module may operate in real time (i.e., converting speech to text as the conversation occurs) or at another time (e.g., as a part of a background processing operation). The mobile computing device 132 or GPS device 134 may continuously stream the geographic location of the owner to the data services system 110 to be stored in data body 115. Again, the data services system 110 may date/time stamp each received location of the owner, such that the location of the owner at any point in time may later be retrieved. The personal computer 136 may perform periodic data backups to the data body 115. The data backups, including different versions of files, may be maintained by the data services system 110 as part of the data body 115. The data backed-up from the personal computer 136 may also be made accessible to other devices and synchronized with versions of the files at other devices, such as the mobile computing device 132. The personal computer 136 may also log and store copies of web pages viewed by the owner in order to retain a records of the owner's web browsing activity. The health monitoring system 144 may utilize sensors worn on/in the body of the owner to monitor health parameters of the owner. For example, heart rate and blood pressure sensors may provide an indication of the owner's mood (e.g., level of excitement/agitation) over time. The experience recorder 146 may be a device (e.g., a hat or helmet) that is worn by the owner and that includes a camera and an audio capture device to continuously capture the sights and sounds experienced by the owner. Again, a speech recognition module may be used to convert voice to text, such that the text of conversations had by the owner may be included as part of the stored data, thereby facilitating indexing and searching of the conversations. The experience recorder 146 may also comprise sensors configured to detect brain activity patterns. For example, a head-worn device such as a cap incorporating sensors may be used to detect information about thoughts and emotions of the owner, such that those thoughts and emotions may be captured concurrently with the sights and sounds experienced by the owner. The data body 115 may therefore comprise not only data regarding activities of the owner, but also data regarding thoughts and emotions of the owner as such activities were performed. Such information may be used later, by the owner, as an extension of their memory and to understand her or his health or behavioral patterns. For example, this may help the owner to understand and therefore better address emotional problems in their lives by becoming aware of physiological reactions to certain life situations. Furthermore, with their permission, the data may be accessed by a health care provider to provide quicker, better treatment and counseling. Such data may be understandable by software which may be able to provide health guidance without involving a human health professional. The increased data and automation may be able to improve the quality of diagnosis and reduce costs.

The home electronics systems may include media systems 150, telephone systems 152, home monitoring systems 154, and gaming systems 156. The media systems 150 may generate information about media content viewed by the owner. For example, such information may be useful in address such questions as whether the owner has seen a particular television show before and thereby help the owner choose another show in the future. The media content information may be used to generate other information about the owner, such as a personality profile regarding the owner, which may change throughout the owner's lifetime. For example, the media programming viewed by the owner may be used to provide an assessment of the types of subjects of interest to the owner, which in the future may be used as input to software which would help the owner become aware of new media which is compatible to their interests or accordant to the change in trends of their interests based on past tendencies. The telephone systems 152 may capture telephone conversations of the owner. Again, a speech recognition module may be used to convert voice to text, such that the text of conversations had by the owner may be included as part of the stored data. Access to such data may be used as a memory assistant for the owner to allow the owner to recall the content and time of occurrence of past conversations.

Contacts system 158, and productivity/time management system 160 may be standalone systems or may be systems that are integrated with other devices. For example, contacts system 158 and productivity/time management system 160 may be implemented in a cloud computing environment and accessible across multiple devices, such as mobile computing device 132, computer 136 and so on.

Genetic testing system 162 may, for example, be a system (e.g., provided as a service by a third party to the general public) that performs genetic mapping. Hence, for example, the owner may decide to have their genome mapped and stored, and other owners may decide to have this service performed as well. Such information may be used to established biological links with other individuals, e.g., to identify family relationship between individuals when such family relationships would not otherwise be apparent from the social media systems. Genetic mapping may also be used to provide information regarding personality traits of the owner and health conditions of the owner, to the extent that such traits and conditions are generically derived. Since the data body 115 is owned by the owner, the dissemination of data can be controlled by the owner. Such information may be used by the owner and their health care providers for the prevention or better treatment of related conditions. Additionally, such information could contribute to health care of the owner's family. As another example, such information may be used for research purposes. For example, research may be performed comparing, for large numbers of people, personality traits of individuals (as determined by an analysis of data in their data bodies) with information about their genome to detect correlations between genetic characteristics and personality traits as manifested across large numbers of people. Since the data body 115 is owned and controlled by the owner, such studies would require the permission of the owner, contingent for example, on sufficient guarantees of privacy. Other types of genetic research correlating biological traits (as captured in data body 115) with genetic traits may also be performed.

The social media systems may include social networking system 164, professional networking system 166, messaging/e-mail system 168, and personal websites/blogs system 170. Data collected from the social networking system 164 and professional networking system 166 may provide information regarding the owner's network of friends and professional colleagues. Accordingly, just as the owner is linked to such other individuals in real life, the data body 115 of the owner may be linked to the data bodies of the owner's network of friends and professional colleagues in the data services system 110 and other data services systems. As will be appreciated, such information may also be supplemented with information from other services.

Additionally, information from the social networking system 164, professional networking system 166, messaging/e-mail system 168, and personal websites/blogs system 170 may be used to capture the owner's views on current topics. For example, the owner may express their views in communications exchanged via the social networking system 164 or via messaging/e-mail system 168. The owner may also express their views via a personal website/blog maintained by personal websites/blogs system 170. The owner may also express their likes and preferences via the social networking system 164. As will be appreciated if such information is not available directly from systems 164-170, the owner may be provided with the ability to post the information (e.g., manually or automatically, e.g., via plugins, widgets, etc.) directly to the data body 115 when the owner is also posting the information to the systems 164-170. Such data may be used by the owner for many useful applications. For example, this data may be fed into software systems that may help the owner find people with similar views for social motivations such as dating, or for potential professional partners.

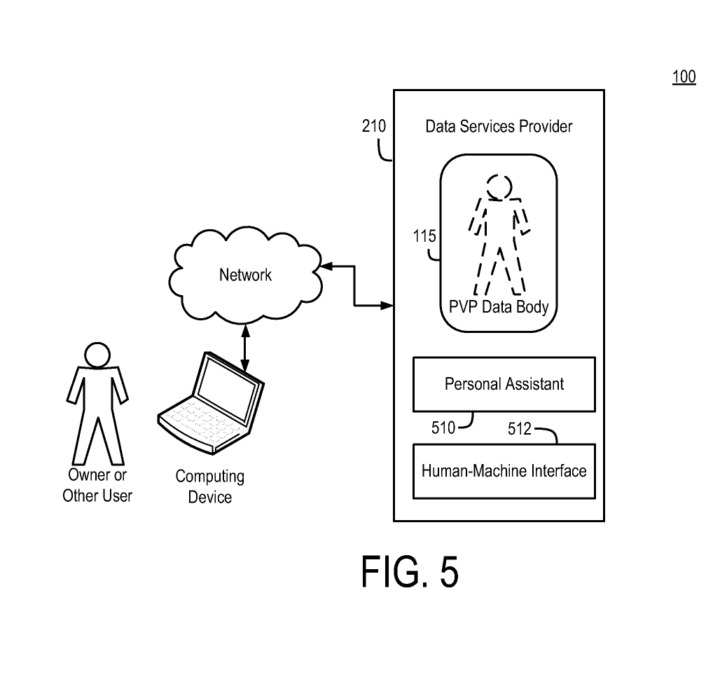

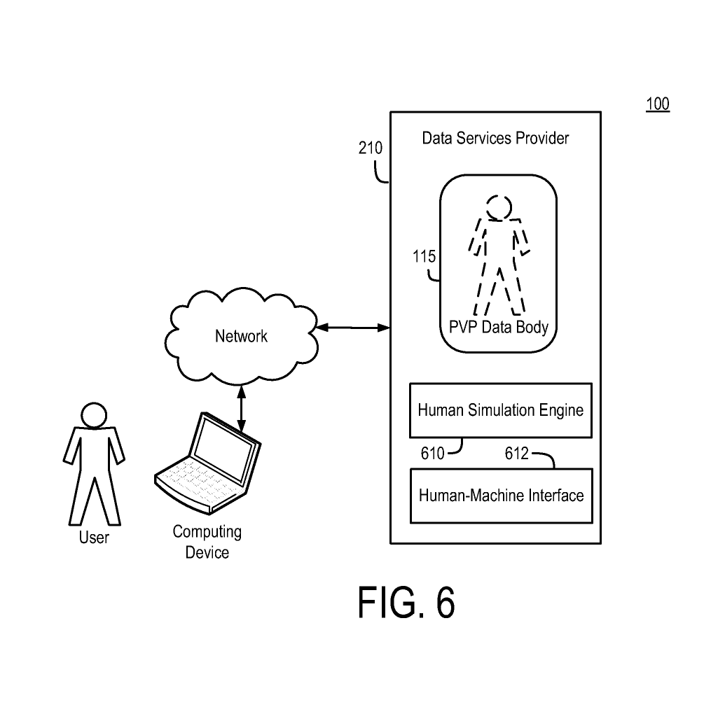

The business systems may include retail systems 182, bank systems 184 and health information systems 186. The retail systems 182 may be used to collect information regarding items owned by the owner, purchasing habits of the owner, interests of the owner, and so on. For example, even if an owner does not purchase the item, the fact that the owner considered purchasing the item may indicate the interests of the owner at a particular point in time. For example, at a later time, this information may be used by the owner's personal assistant (FIG. 5) to alert the owner about the abovementioned item being available at a reduced price. The health information systems 186 may be used to provide information about significant health events that occur during the life of the owner. Such information may also be used to influence the manner in which data for the data body 115 is collected and processed. For example, if during later years of life the owner suffers from significant mental or memory impairment, then events occurring later in life may be less heavily weighted or disregarded altogether in building an overall profile of the personality of the owner during the owner's lifetime. This ability may be useful for human simulation applications discussed below in connection with FIG. 6. Again, if such information is not available directly from systems 182-186 (e.g., due to lack of portability of information stored at systems 182-186), the owner may be provided with the ability to post the information directly to the data body 115.

Other systems may also be used to collect data for storage in the data body 115. For example, government records systems 192 may be used to provide information regarding matters that are of public record. For example, government records systems may provide images of birth certificates, marriage certificates, property titles and court proceedings, and so on.

In an example embodiment, a globally unique identifier may be associated with each data body that is created (i.e., data body 115 and other data bodies for other owners). Such an arrangement promotes portability of the data body 115 and promotes making different data bodies identifiable and distinguishable from each other irrespective of the particular data services provider. The unique identifier may, for example, be based on demographic information regarding the owner (e.g., a name, birth date, birth place, parent names, and so on), national ID numbers, a time-stamped email address, biometric information (e.g., fingerprints, genetic data, and so on), and so on. For example, the use of genetic data may facilitate linking the data body 115 to the data bodies of the owner's relatives and contacts. Other arrangements may also be used.

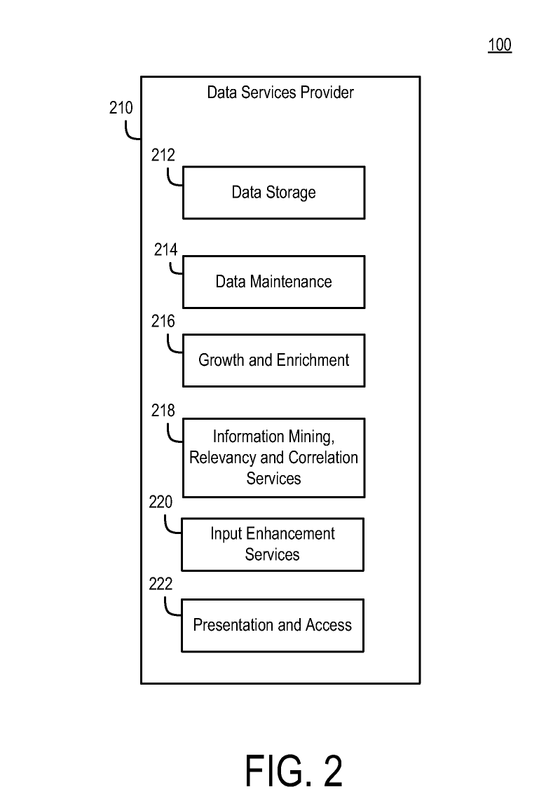

Referring now to FIG. 2, an aspect of implementation of the data services system 110 is shown in greater detail. As shown in FIG. 2, the data services system 110 may be implemented by a data services provider 210. The arrangement in FIG. 2 is shown for a single owner and a single data services provider 210. As will be appreciated, the data bodies for different owners may stored and maintained by the same or different data services providers. Additionally, as previously indicated, the data body 115 for a given owner may be stored and maintained by a series of different data services providers over time, e.g., in the event bankruptcy, unsatisfactory service, etc. As another example, the data body 115 may be maintained by multiple data service provider at a given time for a single owner. For example, one data service provider may maintain a main repository with other data service providers providing additional parts of the service.

As previously indicated, to the extent that more diverse devices 120 are used, and more data is collected, a more robust data body 115 is constructed that provides more detailed impressions of the moments and events in the owner's life. The data body 115 may be viewed as the machine emulation of the owner's long-term memory. The data services provider 210 provides computer-implemented services that maintain and grow the data body 115 and that utilize the machine emulation of the owner's long term memory to provide a personal virtual presence.

The services provided by the data service provider 210 may include data storage service 212, maintenance service 214, growth and enrichment service 216, information mining, relevancy, and correlation services 218, input enhancement services 220, and presentation and access service 222. Fewer, additional and/or different services may also be employed. For example, new services may be added over time as new features and applications are developed and supported. Additionally, while services 212-222 are described below as being performed at the data service provider 210, such services may also be at least partially performed by the devices 120 (e.g., data that has been collected by a device 120 may be preprocessed before it is sent to the data service provider 210 for storage).

The data storage service 212 provides data storage to store the data body 115. For example, such data storage may store redundant copies of the data body at multiple sites at disparate geographic locations. The data storage service 212 may also be configured to ensure that the data remains continuously accessible by computers over time.

In an example embodiment, the data storage service 212 implements bank deposit box equivalent functionality for extremely sensitive portions of the data body 115. For example, for such data, access to the data may require current biometric verification (e.g., iris or voice recognition coupled with current time input) of the owner. As another example, the data may be encrypted such that the data service provider 210 cannot access files without input from the owner. The data service provider 210 may also commit to re-encrypt the files or provide additional layers of encryption, e.g., as older encryption methods become less secure.

The data maintenance service 214 may be configured to perform maintenance of the data body 115. For example, the data maintenance service 214 may be configured to maintain file integrity of the data body 115, i.e., to ensure that the data remains accessible by computers over the long term. The data maintenance service 214 may also audit file validity. The data maintenance service 214 may also migrate all the data to modern systems as such systems become available, including routinely upgrading computers and storage media. For example, such maintenance may include taking aging storage media out of service (e.g., before it becomes physically degraded/inoperable and can no longer be read) and replacing it with new storage media. Such maintenance may also include replacing aging storage media with new storage media that employs current storage formats (physical formats, electronic formats, etc.). This avoids, for example, problems associated with computer readable media that is not compatible with current computer technology (e.g., storing data on tape drives when current computer technology no longer uses that storage format).

The data maintenance service 214 may also be configured to perform logical maintenance of the data body. For example, the data maintenance service 214 may perform ongoing format conversions, i.e., migrating from formats that are aging (but not yet obsolete) to newer, more mainstream formats. Hence, data that is created in a format associated with an application that is in mainstream use at one point in time may be converted to a newer format associated with a newer application that is in mainstream use at a later point in time.

As will be appreciated, in certain cases, fidelity may be lost during format translation. For example, in converting one document format to another, while textual information may be easy to maintain, certain other presentation characteristics of the document (such as typesetting) may be degraded or lost. Likewise, loss of fidelity may occur with audio, image and video conversions. However, even though there may be a loss in fidelity, the data body 115 nevertheless remains useful over time (e.g., much in the same way that ancient manuscripts still provide useful information about the past, even though a certain amount of information content may have been lost). Additionally, in an exemplary embodiment, an original and subsequent copies of the data may also be maintained (i.e., that has not been continuously migrated to newer logical formats over time). Hence, to the extent that other conversion processes become available, the original copy of the data may also be accessed to provide access to any additional information that may not be available via the format-migrated copy of the data. Storing multiple copies of the data body 115 may be rendered commercially practical by exponential decreases in the cost of data storage, which have historically occurred.

In an example embodiment, a portfolio of formats is supported by the data maintenance service 214. Specifically, the data maintenance service 214 may offer a portfolio of formats that are guaranteed for perpetual upgrade. This avoids obligating the data services provider 210 to support every format in existence, including highly obscure formats, which may not be practical. When the owner provides data to the data maintenance service 214, an initial acceptance test may be performed to ensure that the data is valid and conforms to one of the supported formats in the portfolio. Alternatively, the acceptance test may determine that the data can be converted to one of the formats in the portfolio of supported formats.

In an example embodiment, the data services provider 210 provides data statements giving the owner an overview of the state of the data body 115. For example, the statement may provide information (e.g., charts, graphs, etc.) regarding the health of the data body 115 (e.g., showing percentages of the data that is stored in up to date formats, verified as accessible, and so on). The statements may also provide indications of data creation over time, distribution of types of data, and so on. The statements may also provide forecasts future data needs based on past use. Other information may also be provided.

The data maintenance service 214 also maintains links in documents and other content. For example, the data maintenance service 214 may replace links in web pages with permalinks, i.e., permanent links to internet content that is designed to remain unchanged indefinitely. Other internet archival tools may also be used, for example, the archival tool commonly known as the Wayback Machine available at http://web.archive.org/. As another example, in some cases, the data maintenance service 214 may replace or supplement links with a copy of the actual linked content.

The growth and enrichment service 216 provides tools for “growing-the-data” and metadata enrichment. For example, the enrichment service 216 may perform of auto tagging of text, people, objects, and so on, in image, audio, and video files to facilitate future searching. For example, the enrichment service 216 may process images to search for text in images. For example, if a file contains an image of the owner standing in front of a sign for the Magic Kingdom, the term “Magic Kingdom” may be extracted from the image and added as metadata to the image file. If the owner performs a search for “Magic Kingdom,” the image file may be included among the search results. Likewise, the enrichment service 216 service may search for other features in images. For example, if the owner is standing next to the owner's sister-in-law in the image, the enrichment service 216 may include facial recognition logic to identify the face as that of the owner's sister-in-law. The name of the owner's sister-in-law may then be added as metadata to the image file. If the owner performs a search for images containing the owner's sister-in-law, the image file may then be included among the search results. Other icons, logos, objects, and so on, may also be recognized. Likewise, the enrichment service 216 service may also perform facial and object recognition in video files, and may perform speech recognition to convert audio to text and to identify speakers in audio and video files. Again, this information may be added as metadata to the files.

The information mining, relevancy, and correlation services 218 provides services to organize the data contained in the data body 115, for example, to facilitate locating relevant data. For example, the correlation services 218 may index the metadata that is stored with image, audio, and video files based on the recognition techniques discussed above (i.e., speech recognition, image recognition, and so on). The correlation services 218 may also index data according to time, for example, such that a telephone conversation (as captured by mobile computing device 132) may be correlated with a particular event in the owner's life (e.g., a trip to the doctor's office as captured by GPS device 134) based on the fact that the conversation occurred at the same time that the owner was at a particular geographic location. Hence, all of the available data associated with a particular event (e.g., a trip to the doctor's office) may thus be identified based on the data having been collected at the same time that the particular event occurred. This potentially allows for a more complete and enhanced recall of past activities. Likewise, the correlation services 218 may also index data according to other parameters. For example, genealogy information may be stored and be used to index data according to family relationships. Hence, all of the available data associated with the family of a particular cousin of the owner may thus be identified. As another example, if the data body associated with the cousin becomes degraded for some reason, the data body 115 of the owner may be used to at least partially repair the data body of the cousin by providing available information about the cousin. In the same manner, data may also be indexed according to social and professional networks using information provided by the social networking system 164 and the professional networking system 166.

In addition to indexing, the correlation services 218 may also perform other operations. For example, the correlation services 218 may perform statistical analysis of the data to put information in context. For example, the owner may have a number of friends as indicated by data from the social networking system 164. However, an analysis of phone records and e-mail/text records (e.g., the frequency and length of communications) may indicate that the owner was particularly close to friend A during a first period of time and particularly close to friend B during a second period of time. If friend A or friend B passed away at a particular point in time, such analysis may be used as a basis for assessing how traumatic the passing away of the friend was to the owner. As another example, the content of the communications may be analyzed to assess the frequency and emotional intensity of words used in the communications, and this may be used as a further basis for assessing the closeness of the friendship and the impact of the passing away. For example, if communications with one of the friends are characterized by more frequent usage of words with high emotional impact, then that may lead to an assessment that the owner was closer to that friend (other things being equal). These data may be very useful for human simulation applications and other afterlife or legacy applications.

The input enhancement services 220 provides automated aggregation from multiple sources such as social networks, I/O devices logging events/parameters of the owner's life, and so on. For example, if it is desired to create a data aggregation relating to a significant event in the owner's life (e.g., the owner's wedding), the enhancement services 220 may provide such an aggregation. For example, the enhancement services 220 may utilize the time indexing mentioned above to assemble all of the data from the day of the wedding. For example, facial recognition tools may be applied to wedding pictures to determine who was at the wedding. Data from the social networking system 164 may be used to provide additional information regarding wedding guests and their relationship to the bride and groom. Then, at later stages, using the collected data and the data services applications, questions such as. “Was X present at the wedding?” or “How many guests were from the bride's family?” are answerable.

The input enhancement services 220 may also perform statistical and other analysis on the data body 115 to learn about the owner to enable realistic emulations of the owner to be performed in the future. The data body 115 is a highly detailed data set, potentially spanning the entire lifetime of the owner. The data body 115 provides a wealth of data (such as all social and professional interactions and communications that may be used to characterize various aspects of the owner. For example, the enhancement services 220 may examine the lifetime conversations and writings of the owner (e.g., in phone conversations, videos, documents, emails, text messages, social network transcripts) and use this information to enable the memories of the owner to be communicated to others. Additionally, the enhancement services may use this information to characterize the personality of the owner, the owner's views on various topics, level of openness, priorities, preferences, overall attitudes, speech patterns, mannerisms, sense of humor, and so on. For example, the enhancement services 220 may analyze voice conversations of the owner to learn speech patterns of the owner. Additionally, the enhancement services 220 may analyze video recordings of the owner to learn body gestures and other non-verbal cues used by the owner. Other analyses may also be performed, as described in greater detail below in connection with FIGS. 5-6.

The presentation and access service 222 provides searchability, presentation in various formats optimized for various devices and applications, such as file sharing and synchronization, blog hosting, personal web page hosting, and so on. For example, the data service provider 210 may provide for the hosting of a personal web page in perpetuity. The presentation service 222 may also maintain presentation formats, that is, to update web hosting methods or other methods of presenting the data over global communications networks when these change over time, in a manner akin to the manner in which file formats are updated over time. Thus, in addition to “physical hosting”, i.e., facilitating access of the data over the internet, over time conversions may be performed to maintain the presentation of the data.

The presentation and access service 222 may also facilitate monetization of the data body 115. For example, fees may be charged to third parties for accessing the data body 115, e.g., such as by downloading/viewing a document, image, video, e-book or other data. As another, fees may be charged to third parties for interacting with the personal assistant or human simulation (“avatar”) of the owner. As another example, fees may be charged for the sale of virtual money, virtual products and services, and so on.

The data services provider 210 may also be configured to perform specific operations triggered based on time or the occurrence of specific events. For example, the data storage service 212 may be configured to destroy certain data triggered based on the death of the owner. As another example, the data presentation and access 222 may be configured to share certain data triggered based on the death of the owner (e.g., to send posthumous messages and video to loved ones, to publish posthumous messages to the general public, and so on). As another example, the data presentation and access 222 may be configured to share certain information triggered based on the passage of time (e.g., time capsule functionality). As another example, the data presentation and access 222 may be configured to share instructions to an estate on a time or event-triggered basis (e.g., delayed will functionality).

The data services provider 210 may also be configured to receive instructions from individuals other than the owner. For example, the owner may configure a trusteeship to a predefined user (e.g., the owner's spouse) which includes a definition of trusteeship privileges regarding operations that the individual may perform with respect to the data and data services after the owner passes away (e.g. freeze, append only, or complete edit).

From the foregoing discussion, it will be appreciated that the arrangement of FIGS. 1-2 provides the ability to create a data body inexpensively and with minimal required effort. The data body 115, which may constitute all of the owner's lifetime personal data, may be maintained in a consolidated repository or database by the data service provider 210 (as opposed to being stored in a fragmented manner by different entities across disparate locations). The scope and robustness of the data body 115 may be increased by increasing the number of devices 120 from which data is collected. The arrangement enables the creation of a rich, detailed, dynamic and socially interconnected data body 115. The organized and highly detailed impressions of the moments and events in the owner's life has many practical applications. As will be appreciated, therefore, it may be desirable for the data body 115 to potentially persist for long periods, such as beyond the biological life of the owner.

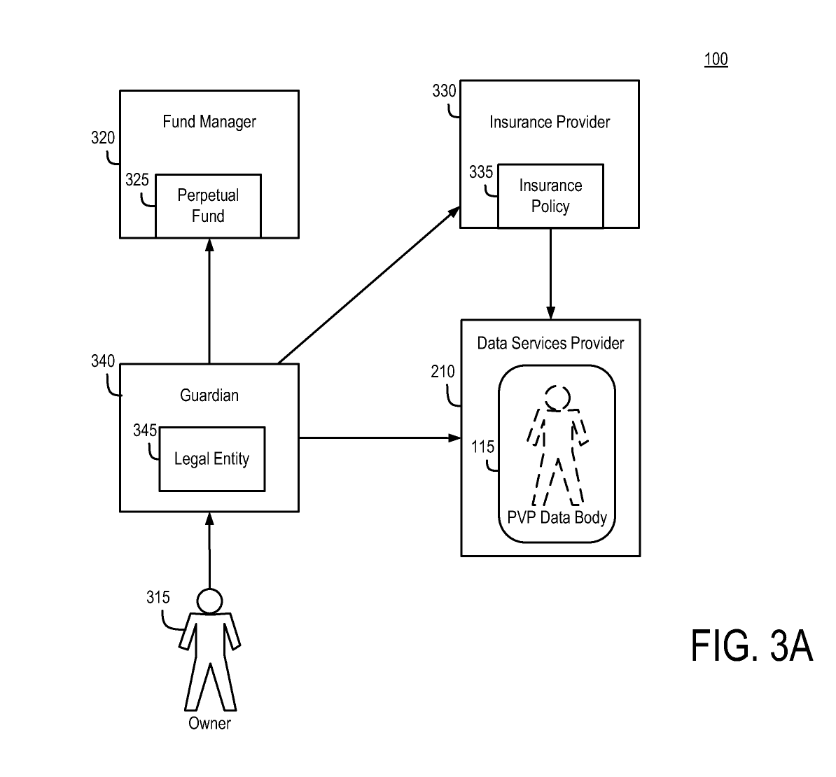

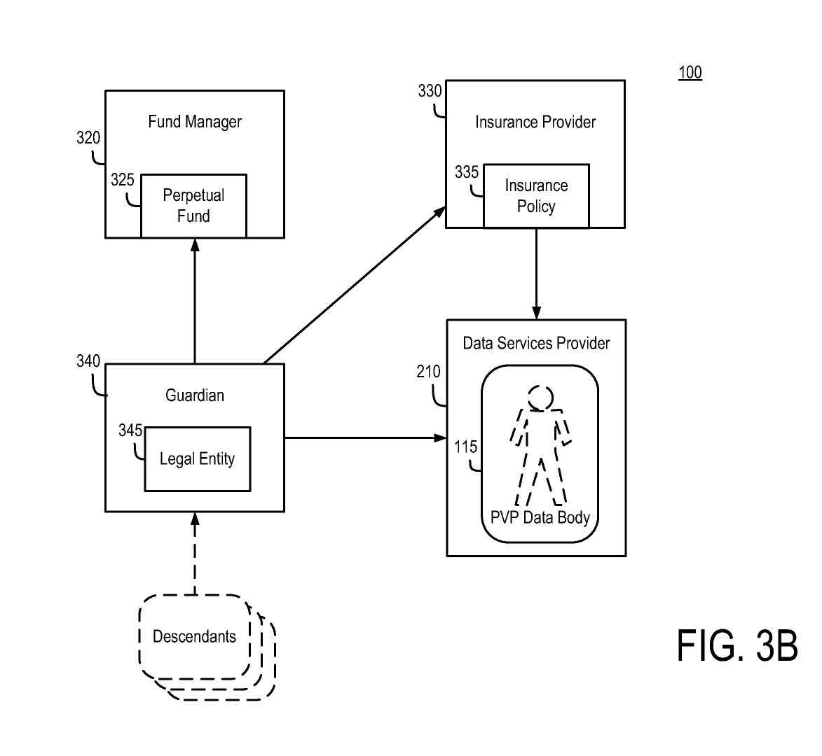

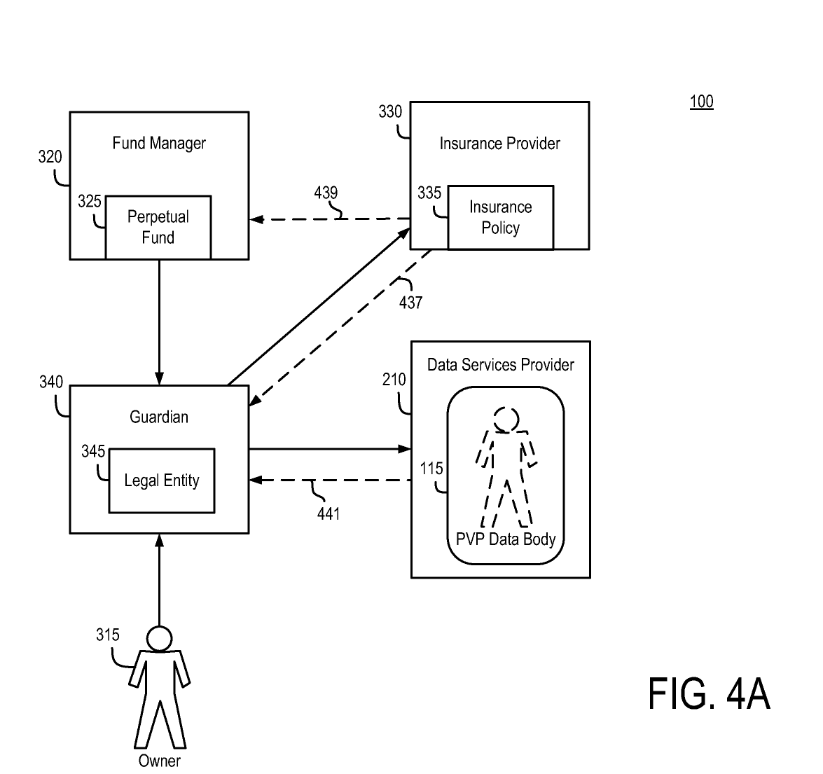

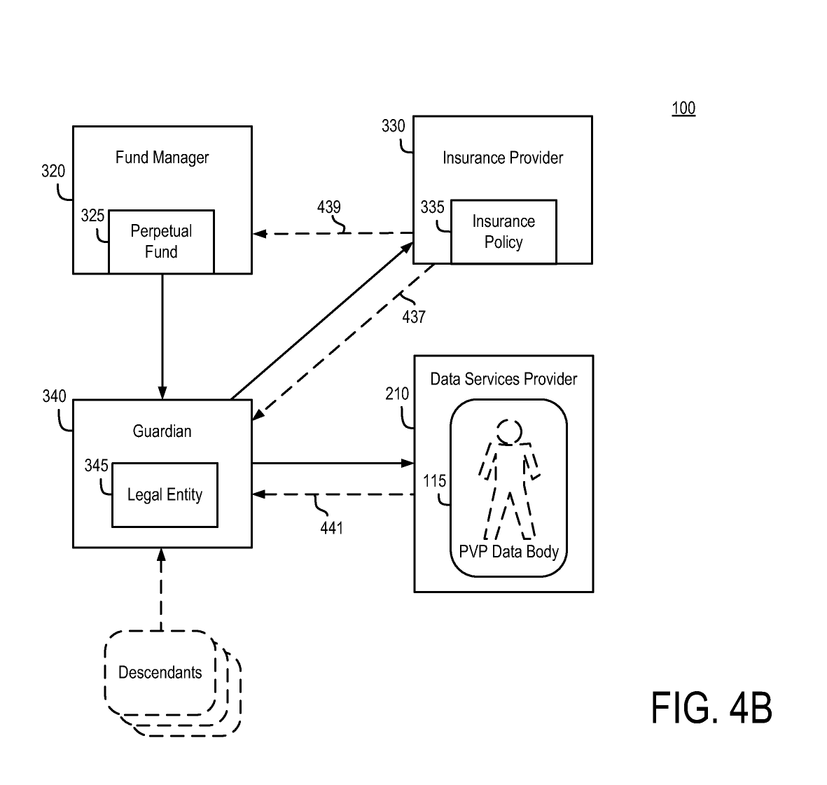

Referring to FIGS. 3A-4B, FIGS. 3A-4B are block diagrams showing an embodiment of a system for long term maintenance and security of personal data. The system shown in FIGS. 3A-4B includes the data service provider 210, which operates in a similar fashion as described in connection with FIG. 2. Additionally, the system in FIGS. 3A-4B includes a fund manager 320, insurance provider 330, and guardian 340. In FIGS. 3A-3B, the arrows represent the flow of oversight/control between the various entities. In FIGS. 4A-4B, the arrows represent the flow of funds between the various entities. FIGS. 3A and 4A show the system during the life of the owner 315, and FIGS. 3B and 4B show the system after the owner 315 has passed away.

The data services provider 210, the fund manager 320, and the insurance provider 330 may operate under the control of the guardian 340. The guardian 340 may serve to promote the long term health and longevity of the data body 115. Associated with the data body may be a legal entity 345 which may, for example, be created and administered by the guardian 340. The legal entity 345 may vary by jurisdiction, for example, it may be a trust, or an account, or a corporation, another form of business organization or another legal entity for the purposes of supporting the functioning of the data body 115. In an example embodiment, the legal entity 345 may be configured to persist for unlimited periods or the maximum period allowed by the jurisdiction governing the legal entity, or may be configured to continue for long periods such as for at least 90 years, for at least 300 years, or more. The legal entity 345 may be configured to exist for a period designated by the owner 315 when creating the legal entity 345 or at a later time. The legal entity 345 may have the ability to own assets such as funds and data. The legal entity 345 may receive income, gifts or bequeathals from various sources including the earnings from the owned funds, income generated from the data body 115 and related services, funds transferred from other similar legal entities, people or commercial bodies, or the sale of assets owned by the legal entity 345. The legal entity 345 may be able to transfer funds or assets to purchase or pay for other assets or services such as the upkeep of virtual assets such as internet domain registry fees or the purchase of investment products. The legal entity 345 may be able to transfer funds as donations or gifts or payment to other legal entities, people or commercial bodies. The legal entity 345 may have the ability to be a beneficiary for an insurance premium. The legal entity 345 may be transferable by the guardian 340 to an alternative legal entity more advantageous for the functioning of the data body 115, related services and assets. The legal entity 345 may have fewer, different, or additional characteristics than those listed.

The fund manager 320 may, for example, be a financial institution (or other entity capable of providing financial management services) that manages a perpetual fund 325. The perpetual fund 325 may, for example, be created by the guardian 340 using funds collected from the owner 315 or from elsewhere, as described in greater detail below. The perpetual fund 325 may then be used by the fund manager, e.g., to issue the monetary instrument. In an example embodiment, the perpetual fund 325 is configured to generate sufficient investment proceeds to both 1) finance the data management services 210 and other services (e.g., as described below) and to 2) maintain the real value, of the perpetual fund 325 over long periods through reinvestment. Specifically, investment proceeds from the perpetual fund 325 may be used to make payments, via the guardian 340, to the data service provider 210 to pay for the services 212-222, e.g., on a periodic (e.g., monthly) basis. As described in greater detail below, the investment proceeds may also be used to make payments for other services, including payments made to the insurance provider 330 to pay insurance premiums and payments to the guardian 340 to pay guardianship fees.

Additionally, in an example embodiment, investment proceeds from the perpetual fund 325 may be used maintain the real value of the perpetual fund 325 over long periods through reinvestment. The perpetual fund 325 may be configured to exist indefinitely beyond the owner's biological life (assuming he or she so wishes). As will be appreciated, however, due to inflation, the cost of providing the above-mentioned services may increase over time. (Such is likely to be the case even if there is a decrease in the real cost of providing such services.) Hence, to offset inflation, a portion of the investment proceeds from the perpetual fund 325 are reinvested back into the perpetual fund 325 itself. By reinvesting investment proceeds in the perpetual fund, and thereby increasing the size of the asset base of the perpetual fund 325, the effects of inflation may be offset. The real value of the perpetual fund 325 is maintained over time, permitting the perpetual fund 325 to serve as a sufficient source of funding despite inflation.

In an example embodiment, an investment mix is chosen (e.g., a mix of large cap stocks, bonds, real estate investments, and so on) such that the perpetual fund 325 provides returns in the range of 1-3% above CPI over very long periods (e.g., greater than 30 years). The returns in excess of CPI may then be used to fund the payments to the data service provider 210 and other services. For example, the perpetual fund 325 may be sized such that investment proceeds of 3% are sufficient to fund payments to data service provider 210 and other services. As part of its service contract, the fund manager 320 may then guarantee investment proceeds of 3% (e.g., provided that the fund is deposited for extended periods of time to account for short term market fluctuations). If the consumer price index for a particular year is 2.5%, then a return of 5.5% is needed to both finance the data management services and other services and to maintain the real value of the perpetual fund 325. To the extent that the fund manager 320 achieves a rate of return in excess 5.5%, that excess represents income for the fund manager 320. Conversely, if the fund manager 320 achieves a rate of return less than 5.5%, the fund manager 320 is nevertheless obligated to provide investment proceeds of 3% to finance the data management services and to reinvest 2.5% to maintain the real value of the perpetual fund 325. (To the extent of any shortfalls, the fund manager 320 is obligated make up any shortfalls with its own funds.) In this example, the actual rate of return does not matter. That is, the fund manager 320 receives income so long as the actual rate of return is 3% above CPI. By way of comparison, for example, such a rate of return would be lower (and therefore, presumably, safer) than the rates of return seen by many public pension funds over the past 25 years. Similarly, long term (30 yr) US Treasury bonds have had an average yield of close to 2% above inflation over the last century. Additionally, as previously indicated, a lower assumed rate of return (e.g., 1% above CPI) may also be used, for example, by increasing the size of the perpetual fund 325. For example, everything else being equal, if $X is used to establish a perpetual fund that is sufficient to fund service payments at an assumed rate of return of 3% above CPI, then $3× will be sufficient to establish a perpetual fund that is sufficient to fund service payments at an assumed rate of return of 1% above CPI.

In an example embodiment, as part of participating in system 100, the fund manager 320 may commit to maintaining the perpetual fund 325 at a stable real value. For example, a required value of the perpetual fund 325 may be linked to an index, such as the consumer price index (CPI) or another index which is more reflective of the real cost of data services. Likewise, as part of participating in system 100, the fund manager 320 may commit to providing investment proceeds to pay for the services 212-222 and other services. As will be appreciated, in some embodiments, the perpetual fund 325 may also increase in value. For example, with permission or request of owners, efforts may be made to monetize the data contained in data body 115 and the data bodies of other owners. To the extent of such monetization, there may be additional funds that are received by the legal entity 345 via the guardian 340 and used to increase the value of the perpetual fund 325. This money flow is shown in FIGS. 4A and 4B by arrow 441. In practice, the money flows between the entities shown in FIGS. 4A and 4B may be implemented using an electronic payment network or in another manner.

In order to establish the perpetual fund 325, the owner may make a one time payment sufficient to establish the perpetual fund 325. Other approaches may also be used to fund the perpetual fund 325. For example, the owner may make an ongoing series of periodic payments (e.g., monthly payments). A portion of each periodic payment may be allocated toward funding the operation of the data services system 110, and a second portion of each payment may be invested in the perpetual fund 325 such that the size of the perpetual fund 325 increases over time. As another example, the owner may take out a loan sufficient to establish the perpetual fund 325, and then repay the loan over time through monthly payments. In any case, the owner may receive the full service from day one as if the owner paid fully upfront.

As another example, the perpetual fund 325 may be established as an additional component of a pension fund of the owner. For example, the owner may pay for ongoing upkeep of the data body 115 during pre-pension lifetime, but allocate part of their annuity/pension policy towards perpetuation of the data body 115 such that the perpetual fund 325 is created at the onset of pension age. In this manner, the perpetual fund 325 may gain one or more of the advantages typically associated with pension funds, such as spread of risks, regulation, taxation advantages, and so on. Pension funds typically employ relatively conservative investing strategies, which helps ensure a continuous stream of funds long into the future. The component of the pension allocated to the perpetual fund 325 may be different than other components of the pension fund (allocated to provide retirement income for the owner) in that there may not be any particular end date to the payouts. In another example, this fund may also support a broad bundle of data services such as computing services, mobile devices, and internet access ensuring that the owner does not have to worry about data and technology costs during retirement. Such an arrangement may help ensure that the data body 1115 continues to grow during the retirement years of the owner. The pension may also include components to fund maintenance of data bodies of dependents of the owner. In alternative embodiments, rather than a pension fund, the perpetual fund 325 may be established as a component of other types of investment instruments, such as mutual funds or mutual insurance. As other examples, the perpetual fund 325 may be created as part of a life insurance payout, via a will or estate, by others in a person's remembrance, or in other ways. As another example, the owner's plan may subsidize the operation of the data services systems 110 or perpetual funds for other family members and friends (e.g., parents, deceased family members, deceased friends, other acquaintances that do not have perpetual funds, and so on). For example, the owner's financing may subsidize a child's data body until a certain age (including the insurance aspects) or to a certain level of service (e.g. size of repository). As another example, individuals that passed away before the proliferation of personal computing may have relatively small amounts of data to store in a data body (e.g., a few pictures, some textual information, scans of letters, etc), making it possible to fund data services for the data body less expensively than for data bodies comprising robust data sets. Such data bodies may then be established and linked to indicate family and friend ties.

In example embodiments, the data service provider 210 may commit to never delete data even if funding is interrupted (i.e., in a situation where the perpetual fund 325 is established through a series of installment payments from the owner 315). This may be implemented, for example, by delaying commencement of the service until a predetermined minimum level of investment in the perpetual fund 325 is reached (e.g., in embodiments where the perpetual fund 325 is established through a series of installment payments). This allows an owner 315 who has lapsed in payments (whether due to disability or for any other reason) to resume service at a later date knowing that data that was previously saved has not been lost.

Once the perpetual fund 325 is established, it is owned by the legal entity 345. The owner may retain ownership of the legal entity 345 during the owner's lifetime and therefore own the principal fund. The owner 315, via the legal entity 345, commits to leaving the perpetual fund 325 deposited with the fund manager 320 for a long term (hereinafter referred to as a “minimum perpetuity period”) in exchange for the commitment of the fund manager 320 for the perpetual fund 325 to provide a given return above CPI. The minimum perpetuity period may, for example, be 30 years. At the same time, the fund manager 320 may commit to permit the withdrawal of the fund at any time. If, however, the refund occurs before the minimum perpetuity period, the commitment may be for the fund manager 320 to return the fund with a possible penalty to recoup the costs incurred by the fund manager 320. For example, the penalty may be staged in a way that the penalty diminishes over time (tapering to no penalty as the minimum perpetuity period is approached). In an example embodiment, the penalty is transparently structured, using accepted and commonly known indexes, allowing easy owner understanding of the penalty. If the refund occurs after the minimum perpetuity period, the commitment may be for the fund manager 320 to return the full amount of the perpetual fund 325 (indexed to CPI).

The insurance provider 330 issues an insurance policy 335 which operates analogously to a health insurance for the data body 115. The insurance policy 335 insures against loss of data. For example, the policy may provide coverage for the loss of original data that was deposited with the data service provider 210 using the system shown in FIG. 1. For example, the insurance provider 330 may provide coverage at a competitive price for a particular data service provider 210 contingent on the existence of mechanisms to enable the retrieval of owner's data (by the insurance provider 330) in case of default (e.g. bankruptcy) of the data service provider 210. If an event that triggers an insurance payout occurs (e.g., degradation of the data body 115), the insurance payout funds may be paid to the PVP legal entity 345 via the guardian 340 (shown as arrow 437 in FIGS. 4A-4B) and used to recreate or heal the data body 115 in a manner as described below.

The insurance policy 335 also insures against loss of viability of data and access to data. As previously indicated, due to continual progress in the way data is stored and the methods to access this data, there is an ongoing need to perform logical maintenance of data. The data service provider 210 performs logical maintenance to upkeep certain kinds (formats) of data so that they will be accessible in the future, e.g., through conversion to newer formats. If the data service provider 210 fails in performing this service, but has not lost the originals, it generally will be possible to perform these conversions at a later stage. The insurance policy 335 may provide coverage to pay for such conversions.

In one embodiment, the insurance provider 330 is a body capable of monitoring/auditing services provided the data services provider 210 and ensuring compliance of the service to acceptable standards. Further, the insurance policy 335 is structured such that the reinstatement of the owner's data (or reinstatement of access to the owner's data) is much less costly than effecting the owner insurance payout. Such an arrangement aligns the interests of insurance provider 330 with that of the owner 315 and the data body 115. Specifically, the insurance provider 330 is motivated to carefully oversee and audit the performance of the data service provider 210 so as to avoid having to make insurance payouts. The insurance provider 330 may also maintain additional backup systems within its control or within the control of trusted third parties. If the data service provider 210 is tempted to skimp on spending for maintenance of the data body 115 (in a conflict of interest with owner), any such deviations from compliance would be detected during audits. The insurance provider 330 may have the leverage to threaten moving the data body 115 to a different provider in conjunction with the guardian 340, and thus motivate the data service provider 210 to comply. This provides a robust structure for overseeing and auditing performance of the data service provider 210 and effectively places the insurance provider 330 in the position of a consumer (owner) advocate. The alignment of interest between the owner 315 and insurance provider 330 induces the insurance provider 330 to endorse only the most reliable data service providers, reducing risks and thereby reducing insurance premiums over time.

As previously mentioned, another service that the data service provider 210 may provide is the access or display of data in perpetuity, such as hosting of a personal web page of the owner 315. Again, in additional to physical maintenance of the hosted website (i.e. facilitating access of the data over the internet), a need exists to logically maintain the hosted website or methods of allowing access to data over global communications networks (e.g., conversions to maintain the presentation or visibility and the functionality of the data). Again, the insurance policy 335 may be structured such that the cost of maintaining such accessibility is significantly less than the cost of effecting the insurance payout. The insurance policy 335 may thus provide protection against the data service provider 210 being negligent in providing the hosting service.

In an example embodiment, a staged insurance is created, imparting layered value to various data sets. Such an approach may be used to accommodate the fact that the loss of data (or loss of access to data) is likely only to be a partial loss, affecting a segment of the data and not the entire data body 115. Additionally, due to the social nature of the data body 115 and the fact that there is overlap with the data bodies of friends, family members, and other individuals known to the owner 315, it is likely that it will always be possible to recreate some or all of the data body 115, given enough resources and cooperation from other data bodies.

In one embodiment, insurance is also provided against inability of the owner 315 to complete perpetual financing. For example, in a scenario where installment payments are used to establish the perpetual fund 325, an unexpected incident (e.g., death or disability) may impair the ability of the owner 315 to make enough payments to establish the perpetual fund 325. In such a scenario, an insurance payout would complete the perpetual fund 325, ensuring survival of the legal entity 345 and the PVP data body 115 (shown as arrow 439 in FIGS. 4A-4B). Such insurance may either be provided by the insurance provider 330 or by another insurance provider. This is essentially a life or disability insurance policy held by the owner, but in which the proceeds are designated to complete financing of the perpetual fund 325 and sized accordingly. Given that this insurance component only relates to the installment financing option, it may be separated from the other insurance components and linked to the loan repayment.

The guardian 340 manages the interests of the data body 115, legal entity 345, and the owner 315 relative to the data service provider 210, the fund manager 320, and the insurance provider 330. The guardian 340 may, for example, be an incumbent institution that manages financial trusts or accounts or other similar entities for large numbers of owners. Primary responsibilities of the guardian may include ensuring health and longevity of the data body 115 and optimizing the development, functionality, intelligence and success of the data body 115 (primarily via 3rd party service providers including the data service provider 210, the fund manager 320, and the insurance provider 330). As stated previously, the perpetual fund 325 is deposited with the fund manager 325. However, the guardian may be the entity that chooses the institution deemed best to fulfill the function of the fund manager 325. In this sense, the guardian 340 also may have a level of fund management responsibility, for example, by performing the necessary due diligence before choosing the institution to be the fund manager 320.

In an example embodiment, the guardian 340 is the central controlling entity (besides the owner 315). The guardian 340 may operate as a broker for the data body 115, the legal entity 345 and the owner 315, e.g., negotiating the best deals with—and overseeing the services of—the data service provider 210, the fund manager 320, and the insurance provider 330. For example, in connection with the fund manager 320, the guardian 340 may be responsible for negotiating the investment of the perpetual fund 325 with a fund manager and choosing the best available entity to serve as the fund manager 320. The guardian 340 may be responsible for monitoring the fund manager 320 and the related market to ensure that the best fund manager option is always being employed in the interests of the data body 115. In connection with the insurance provider 330, the guardian 340 may be responsible for negotiating the various insurance requirements to provide the best value. The guardian 340 may be responsible for monitoring the insurance provider 330 and the related market to ensure that the best insurance option is always being employed in the interests of the data body 115. In connection with the data services provider 210, the guardian 340 may be responsible for ensuring that the data service provider 210 of choice is the best option for the full suite of data services at the most attractive price. In each instance, the guardian 340 may take advantage of group purchasing power associated with having a large customer base to purchase services at wholesale rather than retail pricing. In cases where direct interaction is required between providers, such as the insurance provider 330 monitoring the operations of the data service provider 210, the guardian 340 may be responsible for initiating and coordinating the interactions.

In interacting with the data service provider 210, the guardian 340 may provide information technology services (herein, “virtual life management services”) relative to the data body 115. The guardian 340 may have information technology (IT) expertise, i.e., expertise held above and beyond the expertise of a typical person that is not an IT professional. For example, the guardian 340 may employ accredited IT professionals to provide the virtual life management services. In addition to the services mentioned above, such services may include ensuring the safekeeping, development, and accessibility of the data body 115 via the engagement of data service providers 210. Such services may also include customizing the services environment, via the employment of appropriate data service providers, of the data body 115 to the needs of the owner 315 and characteristics of the data body 115, to the stage of life of the owner, and to the afterlife wishes of the owner. Such services may also include preparing the environment of the data body 115 for future development and change.

The guardian 340 or other guardian may also perform all of the above services with regard to the next of kin of the data body 115. For example, if a data body of a next of kin is degraded, then the data body 115 may be used to rejuvenate the data body of the next of kin. Again, due to the social nature of the data body 115 and the fact that there is overlap with the data bodies of friends, family members, and other individuals known to the owner 315, the data body 115 may be useable in some instances to rejuvenate some or all of the data bodies of next of kin or other individuals.

In the event of an insurance payout, the guardian 340 may facilitate the reception of the funds to the legal entity 345 from the insurance payout and utilize the funds to recreate or rejuvenate the data body 115. During the owner's lifetime, the insurance proceeds may be payable to the owner 315, and the owner may use the proceeds for the benefit of the data body 115 or for any other use. However, after the owner 315 has passed away, the default directive for the insurance proceeds may be to recreate or rejuvenate the data body 115. As will be appreciated, descendants of the owner 315 may also be made aware of the degradation event, and may be in a position to oversee the actions of the guardian 340 in recreating/rejuvenating the data body 115.

As previously indicated, during the owner's lifetime, the owner may own the legal entity 345 and the data body 115. As a service, the guardian administers the legal entity 345 and data body 115 but the owner 315 may be able to override or terminate any guardian actions. After the owner 315 passes away or becomes incapacitated (mentally or otherwise), the guardian 340 manages transitions in the legal entity 345 and data body 115 and oversees inheritance functionality and other event and time based actions relating to the legal entity 345 and data body 115. Such activity may occur in accordance with standard default provisions in the legal entity and/or in accordance with owner-specific customizations to the legal entity. The customization of the individual PVP legal entities may be performed by owners through an automated computer based interfaces. For example, the PVP legal entities may be configured using fully automated on-line configuration forms presented to the owner 315 for completion. As a result, a limited number of types of standardized PVP legal entities may be created, thereby facilitating automated management by the guardian 340 and minimizing the amount of human intervention touching on specific PVP legal entities that is required. The on-line interface may also be configured to pose questions to customize the legal entity 345, e.g., to configure privacy settings, access permissions, other settings relating to the manner in which the data body 115 is disseminated to third parties, and so on. The questions posed may be very specific (to address specific known issues) or may be general in nature (to ascertain general preferences of the owner 315 to facilitate adapting to changing and future circumstances and configuring future options and technology). The general questions may elicit information regarding their general philosophies to adapt the future behavior of the data body and related services to adhere to their wishes. After the owner 315 passes away, the guardian 340 controls such issues in accordance with the owner's instructions and general preferences, unless the owner 315 designates another entity as the controlling entity. For example, the owner 315 may wish to designate the owner's spouse or children as the controlling entity during their lifetime, followed by the guardian 340.

Also, shown in FIGS. 3A and 4A is the relationship of the owner (shown at 315) to the other entities 210, 320, 330 and 340. As shown, during the lifetime of the owner, the owner 315 may own the legal entity 345 and therefore the perpetual fund 325. Similarly the owner 315 may also have full ownership of the data body 115. As previously indicated, the owner 315 may also have extensive ability to control other aspects relating to the data body 115 (e.g., what data service provider is selected by the guardian 340 to maintain the data body 115, the extent (if any) to which the data body 115 may be used for data mining or for advertising purposes, the extent (if any) to which the data body 115 may be used to contribute more generally to society, and so on).

The legal entity 345 may own assets after the owner 315 has passed away or may own assets before the owner 315 passes away, e.g., a living trust. After the owner 315 passes away, the legal entity 345 may own the data body 115 and other assets associated with the data body 115 (e.g., copyrights, domain names, trademarks). Once the owner 315 has relinquished control (e.g., due to death or mental incapacitation), the legal entity 345 becomes the sole owner of the perpetual fund 325, the sole beneficiary of the insurance policy 335, and the sole owner of any additional assets (especially, digital assets that relate to the data body 115). The legal entity may be owned by the guardian 340, by descendants of the owner, or by another entity. Potentially, the entity may be bestowed a level of autonomy negating the need to be owned by any other entity.

As will be appreciated, the owner 315 is also likely to have human descendants. In an example embodiment, such human descendants do not typically serve an executor role in connection with the legal entity 345. Such descendants may, however, be notified in the event of important events (such as degradation of the data body 115). The descendants may be provided with the ability to access and append data to the data body 115 but not to reduce its scope or detract from the perpetual fund 325. In an example embodiment, the guardian 340 remains answerable to the descendants and the descendants may be able to seek legal action in case of neglect by the guardian 340. In an example, the genealogy of owners may be tracked to permit descendants several generations or more later to make decisions on behalf of the data body 115 in some instances (e.g., via an automated computerized interface).

In an example embodiment, the human descendants also do not receive any insurance payouts from the insurance policy 335 that may be precipitated by a lapse in service by the data service provider 210. Rather, such insurance payouts are paid to the legal entity 345, For example, the guardian 340 may control such funds and use them to enhance the data body 115, possibly in an attempt to repair damage resulting from the data loss. Descendants may be aware of the event and may be able to oversee the actions of the guardian. During a person's lifetime, of course, the owner 315 is in control of the legal entity 345 and may decide what to do with the proceeds of any insurance payout.

As will be appreciated, the economics of providing the data services system 110 may change over time. As is known, a given level of service in the information technology industry typically becomes less expensive and vastly improved levels of service or performance become more affordable over time. For example, the cost of data services has been decreasing constantly over the last few millennia (i.e., where “cost” in this context refers to the cost of retaining non-mind data per unit of information (e.g., per word)). To the extent that costs decrease, the long term viability of the perpetual fund 325 is enhanced. In one embodiment, the perpetual fund 325 is a divisible entity such that the owner 315 is able to withdraw only a part of the perpetual fund 325 (i.e., and does not need to withdraw the entire amount). In an example embodiment, to the extent that the economics change after the death of the owner, the guardian 340 is positioned to renegotiate arrangements with data service providers 210, insurance providers 330 and the fund managers 320. In an example embodiment, the guardian 340 is committed to achieve the optimum level of service, in accordance with the owner's preferences, with the available resources such as the income from the perpetual fund 325. If the guardian 340 does not live up to its commitments, the option exists for the owner 315 or the owner's descendants to move the legal entity 345 to another guardian. As another example, insurance may be purchased that provides coverage in the event that the perpetual fund 325 is not sufficient to pay for a specified level of services.

As will be appreciated, all components of the system 100 are portable, i.e., services may be moved from one entity to another. For example, if one data services provider 210 fails, the services can be moved to another data services provider. Hence, even though a single provider may not exist into perpetuity, it can be continuously replaced with new entities that in seriatim provide for uninterrupted service into perpetuity. Such portability also ensures migration to the best data services and monetary management opportunities as these evolve over time. Likewise, if the guardian 340 is not satisfied with the services provided by the fund manager 320, or if the fund manger 320 becomes less competitive, the guardian 340 may move the perpetual fund 325 to another fund manager. Similarly, if the guardian 340 is not satisfied with the performance of the insurance provider 330, then the guardian 340 can establish the insurance policy 335 at a new insurance provider. Additionally, if the owner 315 is not satisfied (or if the descendants of the owner 315 are not satisfied) with the services provided by the guardian 340, or if the guardian 340 becomes insolvent, the owner 315 (or the descendants of the owner) may move the legal entity 345 to another guardian 340.

As previously indicated, the inclusion of additional parties (namely, the insurance provider 330 and the guardian 340) beyond the data services provider 210 and the fund manager 320 enhances the long term durability of the system. By including additional parties, the potential for a single point of failure is reduced. For example, if the data services provider 210 goes bankrupt, another data services provider may be engaged to fill that role. The same is true for the fund manager 320 and the insurance provider 330. If the guardian 340 goes bankrupt, the human descendants can ensure that a new guardian is engaged. Additionally, the arrangement provides for oversight of the services provided by the data service provider 210. Specifically, such oversight is provided by the insurance provider 330 and the guardian 340. The insurance provider 330 in particular is incentivized to act as a consumer advocate on behalf of the data body 115. As will be appreciated, the data service provider 210, the fund manager 320, the insurance provider 330 and the guardian 340 should be distinct companies adhering to a clear set of antitrust standards in order to fully attain the benefits of including such additional independent and separate parties. In one embodiment, due to practicalities of the offered services of current insurance companies, the fund manager 320 and insurance provider 330 may be the same company without deducting significantly from the concept of separation of interests and prevention of conflicts of interests described above.

From the foregoing discussion, it will be appreciated that the arrangement of FIGS. 3A-4B provides the ability to maintain the data body 115 for long periods. As will also be appreciated, the organized and highly detailed impressions of the moments and events in the owner's life as captured in the data body 115 have many practical applications.

Referring now to FIGS. 5-6, various examples of applications that may be provided using the data body 115 are illustrated. While certain examples discussed in connection with FIGS. 5-6, it will be appreciated that many others may also be provided.

Referring first to FIG. 5, an arrangement is shown in which the data body 115 is used to provide a personal assistant 510. The personal assistant 510 may comprise a human-machine interface 512 which may, for example, include a speech-to-text converter (to receive oral instructions and inquiries from the owner) and a text-to-speech converter (to provide responses back to the owner). In FIG. 5 the human-machine interface 512 is shown as part of data services provider 210 but similar functionality may also be performed in other parts of the system such as in mobile computing device 132 or personal computer 136 or in other devices. For example, the human-machine interface 512 may be implemented using a software application executing on the mobile computing device 132 (e.g., smartphone). The human-machine interface 512 may also include the hardware (e.g., microphone, speaker) via which sound is communicated to and from the user. When the owner 315 has a request to make of the personal assistant 510, the owner 315 may speak into the mobile computing device 132, the speech of the owner 315 may be converted to text, the text may be sent for processing to the personal assistant 510, a text response to the query may be generated by the personal assistant 510, and the text response may be converted to speech and communicated to the owner 315 via the mobile computing device 132. Other hardware configurations are also possible.

The personal assistant 510 may be used by the owner 315 to assist with everyday tasks. For example, the personal assistant 510 may assist the calendar with appointment scheduling. For example, the owner 315 may provide the personal assistant 510 with instructions that state, “Please set up a meeting with John for next Thursday at ten.” The verbal instructions may then be converted to text and sent for processing to the personal assistant 510. The phrases and terms “set up” and “meeting” may be used by the personal assistant 510 to understand the overall nature of the request (i.e., scheduling a new appointment). To the extent that there is uncertainty, the personal assistant 510 may respond with one or more questions to clarify the nature of the request. For example, the personal assistant may state, “I′m sorry, I do not understand your request. Could you please ask me again.” The owner 315 may then ask the question differently, such that the additional keywords may be used by the personal assistant 510 to properly interpret the owner's request. As another example, the personal assistant 510 may state, “You want me to create a new appointment in your calendar for a meeting with John. Is that correct?” Once the owner 315 and the personal assistant 510 reach agreement as to the nature of the task to be performed, the personal assistant 510 may proceed with processing the owner's request. As will be appreciated, the personal assistant 510 may learn the owner's speech patterns over time, e.g., may learn that the owner 315 typically uses the phrase “set up a meeting” when the owner 315 wants to schedule an appointment. Likewise, the personal assistant 510 may begin responding in a manner which more closely emulates that the speech patterns of the owner, e.g., by using the phrase “set up a meeting” instead of “create a new appointment” in its responses to the owner.

As will be appreciated, in some instances, the personal assistant 510 may have follow-up questions or need additional information in order to complete the task requested by the owner, e.g., to complete optional and/or required fields in a template used to create the new appointment. For example, the personal assistant may ask, “Do you mean 10 AM or 10 PM?” As another example, the personal assistant may also ask, “Would you like me to send John a meeting request for the meeting?” Assuming the owner 315 responds affirmatively, then the personal assistant may need to more clearly identify the “John” to whom the owner 315 is referring. For example, there may be another person talking in the background, which the personal assistant is able to identify as “John Smith” based on a comparison of the speech patterns of the person talking with speech patterns of people named “John” prior recorded conversations stored in the data body 115. The personal assistant may state, “That sounds like John Smith talking in the background. Is that the ‘John’ to whom you are referring?” Assuming the owner 315 responds affirmatively, the personal assistant may then retrieve the most recently e-mail address used for John Smith, and send a meeting request to that e-mail address.

As another example, the personal assistant 510 may be used to interact with third parties. For example, the owner 315 may receive a telephone call from the third party. Rather than automatically placing the caller into voicemail, the personal assistant 510 may first answer the telephone call on behalf of the owner (e.g., “Robert”) and attempt to assist the caller. For example, the personal assistant 510 may state, “Hello, my name is Jane. I am Robert's personal assistant. May I help you?” The caller may then state, for example, “Yes, I would like to set up a meeting with Robert for next Thursday at ten.” The personal assistant 510 may then proceed to create a new appointment in the owner's calendar in the manner described above, including asking additional questions of the caller to the extent necessary. Again, the personal assistant 510 may use voice recognition or other mechanisms to identify the caller and to determine the caller's name. Additionally, if the caller has made similar requests to the personal assistant 510 in the past, the personal assistant 510 may learn the caller's speech patterns over time, e.g., may learn that the uses the phrase “set up a meeting” when the caller wants to schedule an appointment. If the caller does not wish to be helped by the personal assistant, or the personal assistant 510 is not able to help the caller (e.g., because the personal assistant 510 is not able to interpret the caller's request), then the caller may be placed into voicemail.

As another example, the personal assistant 510 may respond to other inquiries from the owner 315 or from third parties. For example, the owner 315 may receive a call from a third party asking, “Is Robert going to the Cunningham's wedding next weekend.” The personal assistant 510 may then check the owner's calendar for any appointments containing the terms “wedding” or “Cunningham,” and respond appropriately. As will be appreciated, the personal assistant 510 may be configured to perform searches of other data contained in the data body 115 (e.g., to perform searches of e-mail and text message communications) to expand the range of terms used in analyzing the owner's calendar appointments during the weekend in question (e.g., to include the first names of the Cunninghams in the analysis of calendar appointments). As another example, the owner's e-mail and text message communications may include information that is directly responsive to the inquiry. For example, the owner 315 may have sent an e-mail to a friend or relative stating, “Kaitlyn and I decided that we are going to attend the Cunningham's wedding.” The personal assistant 510 may then pass along such information to the caller (i.e., assuming the owner 315 has not otherwise designated the owner's calendar appointments or the corresponding e-mail/text message communications as “private”). If uncertainty exists as to whether a passage of e-mail text is responsive to the caller's inquiry, the personal assistant 510 may be configured to read the e-mail text to the caller and ask if the text is helpful. For example, the personal assistant 510 may state, “Robert e-mailed his daughter last week saying, ‘I′m looking forward to seeing you and Mike at the Cunningham's wedding.’ Is this helpful to you?” If the e-mail text is not helpful, this process may be repeated until the caller is provided with information that the caller considers responsive to the caller's question. As another example, if the personal assistant 510 finds a calendar entry for the wedding on the owner's calendar, the personal assistant 510 may respond, “Yes, it appears that Robert is planning on attending. To be sure, would you like for me to check with Robert and get back to you?” For example, such a response may be appropriate if the personal assistant 510 determines (based on a historical comparison of calendar data and GPS data) that the owner 315 sometimes places appointments on his calendar but ultimately does not attend the appointment.

As another example, the personal assistant 510 may be configured to perform tasks. For example, the personal assistant 510 may make telephone calls on behalf of the owner. For example, the owner 315 may request that the personal assistant 510 call the doctor's office to schedule or cancel an appointment, make hotel/restaurant reservations, and so on. For example, the owner 315 may provide the personal assistant 510 with instructions stating, “Please make dinner reservations at a restaurant near my office for four people for 7:00 PM.” The personal assistant 510 may then assemble a list of potential restaurants based on restaurants the owner 315 has enjoyed dining at in the past (e.g., as evidenced by recorded conversations during or after visits to such restaurants, as evidenced by recorded emotions captured during or after visits to such restaurants, etc.). The personal assistant 510 may then place calls to the various restaurants, stating “I would like to make reservations for four people at 7:00 PM. Do you have an opening at that time?” When a restaurant is located that has an opening, the personal assistant 510 may provide the owner's name for the reservation, and then terminate the process.

As another example, the personal assistant 510 may also be configured to perform extrapolations based on data contained in the data body 115. For example, the personal assistant 510 may be configured to recommend items that may be of interest to the owner 315 (e.g., products, services, etc.). For example, in the previous example, where the owner 315 seeks to make a restaurant reservation, it may instead be the case that the owner 315 is in a new city. In that scenario, for example, the personal assistant 510 may scan the websites of nearby restaurants to perform a comparison of those website with the websites of restaurants that the owner 315 is known to enjoy. For example, the personal assistant 510 may look for similar words or phrases (e.g., “elegant,” “casual,” “romantic,” etc.), similar menu selections and pricing, similar user comments on ratings/feedback websites, and so on. The personal assistant 510 may proceed with making reservations at the selected restaurant in the manner noted above. As another example, the personal assistant 510 may identify news articles that may be of interest to the owner 315 based on a knowledge of what news articles the owner 315 has read in the past. As another example, the personal assistant 510 flag e-mail correspondence as being particularly important or urgent, based on a knowledge of the owner's previous interactions with the sender (e.g., the sender is considered important to the owner) and based on a review of message content (e.g., a line in the e-mail message states “please contact me urgently”).

The personal assistant 510 may also be configured to provide personalized teaching to the owner. The personal assistant 510 has a significant understanding of what is already known by the owner 315 and already knows the owner's weak and strong spots. Thus, the learning can be adapted to the owner's needs by refraining from teaching subject matter already mastered by the owner 315 and thus avoiding boring the owner. Additionally, the personal assistant 510 may also be able to teach the owner 315 about himself/herself, e.g., using the vast amount of data that may have been stored about the owner 315 in the data body 115 to provide enhanced self-awareness.

As another example, the personal assistant 510 may be configured to provide memory assistance to the owner. For example, the personal assistant 510 may include a search engine that intelligently searches, understands and correlates data from the data body 115. Such information may be provided to the owner 315 or, at the discretion of the owner, to third parties. For example, the owner 315 may state, “When I was talking to my mom yesterday, she said that she and dad will be coming to visit in August. I forget what dates she said, though. Could you go back and check the conversation to find out what dates they are coming?” Based on the terms “check” and “conversation,” the personal assistant 510 may discern that the owner 315 would like for the personal assistant 510 to perform a search of conversation transcripts stored in the data body 115. Based on the term “yesterday,” the personal assistant 510 may discern that the search should be limited to conversations that occurred the preceding day (or that conversations occurring the preceding day should be weighed more heavily in the search results). Based on the phrase “with mom,” the personal assistant 510 may discern that the search should limited to limited to conversations with the owner's mother (or that such conversations should be weighed more heavily in the search results). Again, whether a particular conversation was with the owner's mother may be determined, for example, based on caller ID, voice recognition, etc. stored as metadata for the conversation transcript. The search engine may then search the pertinent transcript(s) for terms such as “August” and “visit” (and potentially other similar/synonymous terms). Any pertinent information may then be passed along to the owner. Again, the personal assistant 510 may be configured to ask clarifying questions if there is uncertainty regarding the search parameters to be used for the search. Likewise, if uncertainty exists as to whether a passage of e-mail text is responsive to the owner's inquiry, the personal assistant 510 may be configured to read the pertinent portion of the conversation transcript and ask if that text is helpful. For example, the personal assistant 510 may state, “Your mother stated, ‘We'll be in New York the third week in August.’ Is this helpful to you?” If the quoted passage of the conversation transcript is not helpful, this process may be repeated until the owner 315 is provided with information that is responsive to the owner's question.

The personal assistant 510 may also be configured to answer questions that involve correlating data from a number of sources. For example, the owner 315 may ask, “when was I sick during the last few years?” The personal assistant 510 may correlate a number of indicators (e.g., doctor office visits (GPS logging), medical bills, emails to friends mentioning the illness, and so on) to provide an answer to such a question. Further, the personal assistant 510 may include pattern recognition and correlation program logic to expose information that would not otherwise be apparent. For example, by recognizing occurrences of sickness and analyzing previous events, the personal assistant 510 may be able to detect common patterns leading up to the various cases. The personal assistant 510 may then educate, forecast, and warn the owner 315 when similar conditions prevail in the future, e.g., to prevent an otherwise impending illness.

As previously indicated, assuming a sufficient number of devices 120, the data body 115 may be store highly detailed impressions of all moments and events in the owner's life. Hence, the range of questions regarding the owner's life that may be answered in the manner described above is essentially unlimited. For example, if the owner 315 wants to know when the owner 315 was at certain locations (e.g., when the owner last visited the doctor), such questions may be answered using GPS data from the mobile computing device 132 or the GPS device 134. As another example, if the owner 315 wants to know about certain content the owner 315 may have viewed on the internet, such questions may be answered using stored web pages from the computer 136. As another example, if the owner 315 wants to know about things the owner may have seen or heard in the past, such questions may be answered using information from the cameras 140, 142 or from the experience recorder 146. For example, images or videos retrieved from the data body 115 that may be responsive to the owner's inquiry may be displayed via a display of the mobile computing device 132. Any information that is collected by the devices 120 may be potentially be the subject of a search and may be used to provide memory assistance to the owner.

Referring to FIG. 6, an arrangement is shown in which the data body 115 is used by a human simulation engine 610 to provide a human simulation. In FIG. 6 the human-machine interface 612 is shown as part of data services provider 210 but similar functionality may also be performed in other parts of the system such as in mobile computing device 132 or personal computer 136 or in other devices. The human-machine interface 612 may also include the hardware (e.g., microphone, speaker) via which sound is communicated to and from the user. To the extent a video interaction is provided, the human-machine interface 612 may also include the display of the computing device 132, personal computer 136, or other device. The human simulation may be used during the lifetime of the owner. For example, a famous actor, music star, or other public figure may use human simulation to assist correspondence with fans. The human simulation may also be used after the owner 315 passes away, e.g., to provide a virtual representation of the owner 315 with which descendants or other people or other machines may interact, e.g., via the internet or other global communication network. The human simulation may be configured to interact differently for different people in a similar way to a human. For example, there maybe one level of interaction for family members and another for the general public. The simulation engine 610 may interact in a customized way for particular people by retaining information about previous interactions in a similar way to a human.

The human simulation engine 610 may be trained to emulate the owner 315 based on the data body 115, thereby providing a more accurate emulation of the owner 315 that is less easily noticeable as being a mere emulation to the casual observer. As previously indicated, the data body 115 may be the result of a lifelong process of imprinting, preserving and consolidating an individual's presence. That is, the data body 115 may be created in real time as the owner 315 proceeds through life (as opposed to being recreated later). The data body 115 may consolidate the owner's entire lifetime of personal data in location consolidated repository, including e-mail and other correspondence, voice conversations, images, videos, and so on. Hence, the human simulation engine 610, with access to such data, may depict a rich and colorful memory of the owner's life. Due to the arrangement shown in FIGS. 2, 3A-3B and 4A-4B, such emulations may be provided long into the future, beyond the lifetime of the owner.

The human simulation may be configured to emulate the owner 315 and to allow others (e.g., fans, descendants, etc.) to have a simulated interaction with the owner. In addition to emulating the physical likeness of the owner 315 (e.g., in a manner akin to video), the human simulation may emulate other aspects of the owner, such as the owner's personality, the owner's speech patterns, the owner's views on various issues, and so on. For example, the human simulation may be generated so as emulate the owner's appearance based on photographic and video data of the owner. The human simulation may also be generated so as to emulate the owner's voice based on audio recordings of the owner. The human simulation may generated so as to express the same views as the owner 315 based on e-mail, text messages, conversations, and so on, of the owner. The human simulation engine may be used to provide the internal logic for physical robots or human lookalike geminoids.

In an example embodiment, the human simulation engine 610 is used to provide a virtual representation of the owner 315 accessible to descendants for a simulated chat via the internet. For example, the descendant and the human simulation may interact via a two-way video chat using a personal computer of the descendant. The descendant may pose a question to the human simulation, for example, “Please tell me about your wedding day.” The human simulation engine 610 may then decide how the owner 315 would have answered such a question. In one embodiment, communications of the owner 315 may be analyzed to create a database of canned statements and soliloquies on a range of topics. Such prepared statements and soliloquies may pull together earlier statements that the owner 315 made on such topics. Keywords from the question/statement made by the descendant (e.g., “your wedding day”) may then be used as an index to the database to access a statement that is likely to be responsive to the statement/question made by the descendant.

In another embodiment, such responses are generated in real time. For example, after a question/statement is received from the descendant, the human simulation engine 610 may access data from e-mails, conversations, and other communications from the owner 315 stored in the data body 115. For example, the human simulation engine 610 may look for situations in which the owner 315 was asked the same or similar question. To the extent that the question is identical to the question just asked by the descendant, the answer provided to that question may be ranked higher in the list of potential responses to the descendant's question. As another example, the human simulation engine 610 may look for situations in which the owner 315 spoke or wrote about at length about the owner's wedding. More generally, the human simulation engine 610 may pick out key words from the question posed from the descendant and search prior communications of the owner 315 for communications that use the same or similar words. Additionally, key words selected from earlier portions of the conversation with the descendant may also be used to evaluate the earlier statements made by the owner (e.g., to ensure that the context of the conversation remains consistent). The greater the degree of similarity, the higher the proposed response is ranked. One a response is selected, the response may be provided to the descendant.

As will be appreciated, the response that is provided by the human simulation engine 610 may also be selected on other factors in addition to word similarity. For example, the response may be selected based on the person that is interacting with the human simulation. For example, if the owner 315 spoke about the owner's wedding on a number of occasions, the human simulation engine 610 may select a response that was provided to a person that had similar demographics to the person interacting with the human simulation. For example, if the person interacting with the human simulation is ten years old, the human simulation engine 610 may select a response that was originally provided to a ten year old. As will be appreciated, the statements that the owner 315 might make regarding various topics may vary widely depending on the age and other demographics of the person to whom the statement is being made. The demographic profile of the original recipient of the statement may be stored as metadata for the original communication (e.g., stored with the transcript of the original conversation with the ten year old) or may be deduced from the nature/content of the data.

The human simulation may also be generated so as to emulate the personality, sense of humor, mannerisms, speech patterns, gestures, level of openness, and so on of the owner. For example, if the owner 315 had a personality that sought to avoid conflict (e.g., as indicated by telephone conversations maintained in the data body 115), the video image of the descendant may be monitored for signs of conflict. Upon detecting such conflict, the human simulation may start making statements that are less directly related to statements made by the other person (i.e., may seek to change the conversation).

The human simulation may be generated so as to emulate the owner 315 at different stages in the owner's life. For example, the human simulation may be made to emulate the owner 315 at age 10 based on data collected through age 10, to emulate the owner 315 at age 20 based on data collected through age 20, to emulate the owner 315 at age 40 based on data collected through age 40, to emulate the owner 315 at age 80 based on data collected through age 80, and so on. Thus, for example, a ten year old descendant may interact with a human simulation that reflects their grandparent at age ten.

As examples, the personal assistant and human simulation have been described above. It will be appreciated, however, that many characteristics of the personal assistant are common and useful for the human simulation application and vice versa. In practice, the characteristics of these and other PVP applications may be customized for specific uses and preferences of the original owner, other users, and other applications.

The human simulation and human assistants may be configured to emulate real life functions, social positions or roles, and therefore interact with other such entities, emulating and augmenting real life interactions. As an example, a parent and a child may each have a personal assistant or simulation (herein “the parent assistant” and “the child assistant”) configured to emulate the real life interactions of the parent and child. That is, the parent assistant may relate to the child's assistant analogously to the way in which the human parent relates to the human child. Following a previously described example in which the human assistant detects patterns indicating an impending illness, once such an event is detected by the child assistant, this information may be relayed to the parent assistant. The parent assistant may then relay this information to the human parent, allowing the human parent to be aware of the problem and to take preventative action. As another example, the parent assistant and the child assistant may cooperate to monitor the virtual environment of the human child. Human parents cannot physically be present to supervise all of the human child's computing device use and online behavior. An appropriately configured child assistant, however, can monitor all the child's computing device and software use, electronic interactions with others, and other online behavior. For example, a child assistant may be able to prevent a child from conveying personally identifiable information in an online communication with a stranger. Further, after this event is prevented, the child assistant may relay information about the event to the parent assistant, which may then relay the information to the human parent, who would then be able to take steps to educate the child regarding safe online behavior. Similarly, the child assistant may be able to monitor the child's social interaction with friends and thereby detect that the child is having social problems, allowing the parent to be become aware of these issues, and take action to assist the child. As will be appreciated, many other useful applications are possible using the described system. Additionally, similar role simulations and interconnections between human assistants and simulations apply, not only to many social relations and to interactions, but may also apply to professional relations. For example, a vendor's assistant may detect that a client's assistant is indicating displeasure about the vendor's product or services, e.g., by posting such comments on a publicly open social media site. The vendor's assistant may then notify the vendor, allowing the vendor to take corrective action.

The embodiments of the methods and system have been described with reference to drawings. The drawings illustrate certain details of specific embodiments that implement the systems and methods and programs of the present invention. However, describing the invention with drawings should not be construed as imposing on the invention any limitations that may be present in the drawings. The embodiments described above contemplate methods, systems and program products stored on any non-transitory machine-readable storage media for accomplishing its operations. The embodiments may be implemented using an existing computer processor, or by a special purpose computer processor incorporated for this or another purpose or by another system.

Embodiments can include program products comprising non-transitory machine-readable storage media for carrying or having machine-executable instructions or data structures stored thereon. Such machine-readable media may be any available media that may be accessed by a general purpose or special purpose computer or other machine with a processor. By way of example, such machine-readable storage media may comprise RAM, ROM, EPROM, EEPROM, CD-ROM or other optical disk storage, magnetic disk storage or other magnetic storage devices, or any other medium which may be used to store desired program code in the form of machine-executable instructions or data structures and which may be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the present invention have been described in the general context of method steps which may be implemented in one embodiment by a program product including machine-executable instructions, such as program code, for example in the form of program modules executed by machines in networked environments. Generally, program modules include routines, programs, logics, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments of the present invention may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments of the invention may also be practiced in distributed and cloud computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

It should be noted that although the discussions herein may refer to a specific order and composition of method steps, it is understood that the order of these steps may differ from what is described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present invention. Such variations will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated. Other substitutions, modifications, changes and omissions may be made in the design, operating conditions and arrangement of the embodiments without departing from the scope of the present invention.

Throughout the specification, numerous advantages of the exemplary embodiments have been identified. It will be understood of course that it is possible to employ the teachings herein without necessarily achieving the same advantages. Additionally, although many features have been described in the context of a particular data processing unit, it will be appreciated that such features could also be implemented in the context of other hardware configurations.

While the exemplary embodiments illustrated in the figures and described above are presently preferred, it should be understood that these embodiments are offered by way of example only. Other embodiments may include, for example, structures with different data mapping or different data. The invention is not limited to a particular embodiment, but extends to various modifications, combinations, and permutations that nevertheless fall within the scope and spirit of the appended claims.

What is claimed is:

1. A method comprising
creating a legal entity that is associated with an original owner, a dedicated data body and data services for the dedicated data body;
creating a fund, associated with the legal entity, which is managed by a fund manager;
establishing an insurance policy, associated with the legal entity, which is issued by an insurance provider.

2. A method as defined in claim 1, wherein the legal entity is configured to persist beyond the duration of the original owner's lifetime for one of (1) a period designated by the original owner, (2) a period in excess of 90 years, and (3) a maximum period stipulated by law in a jurisdiction limiting continuance of the legal entity.

3. A method as defined in claim 1, wherein the legal entity at least one of (1) owns assets including the fund and the dedicated data body, and (2) is designated as a beneficiary for an insurance policy.

4. A method as defined in claim 3, wherein the legal entity is at least one of a trust, a charitable trust, an account, a corporation, and a business organization.

5. A method as defined in claim 1, wherein the original owner is at least one of a person, a group of people, a family, a religious organization, a sports team, a business, a music group, an animal, and a social entity.

6. A method as defined in claim 1, wherein the original owner is a deceased person or a social entity relating to deceased people and the legal entity is created on behalf of a living person or an organization.

7. A method as defined in claim 1, wherein the legal entity creating step, the fund creating step, and the insurance policy establishing step are performed by a guardian, wherein the legal entity is managed by the guardian, and wherein the guardian functions as agent for the original owner and the legal entity, with information technology expertise and group purchasing power, negotiating with and engaging data service providers and insurance providers to service and protect the dedicated data body and related services.

8. A method as defined in claim 7, wherein the guardian is a first guardian, and wherein the first guardian transfers the legal entity to a second guardian responsive to instructions from the original owner or another controlling trustee of the legal entity.

9. A method as defined in claim 7, further comprising receiving inputs from the owner specifying actions of the legal entity and the guardian, the inputs being received using an automated computerized interface, the automated computerized interface comprising a configuration form that includes questions to elicit information regarding general philosophies of the person regarding maintenance and dissemination of the dedicated data body in future circumstances.

10. A method as defined in claim 9, wherein the receiving includes receiving future required actions, ownerships and inheritance behaviors of the legal entity, guardian and dedicated data body, pertaining to life and death events including the legally recognized loss of mental ability of the original owner, the death of the original owner, and other events not directly controllable by the original owner.

11. A method as defined in claim 1, wherein the dedicated data body comprises data relating to the original owner, the data including electronic records, videos, voice recordings, emails exchanged, documents authored, transcripts of social networking interactions, and location and other sensory data collected by mobile devices.

12. A method as defined in claim 1,
wherein the data services are performed by one or more data service providers including storage, maintenance, and provision of access and use of the dedicated data body,
wherein at least one of the data service providers ensures long term validity of a specified set of data format types, including acknowledging receipt of data in one of the data format types, and thereafter undertaking to convert the data to new formats as the new formats replace, in widespread use, previous formats for the data format type.

13. A method as defined in claim 1, wherein the fund is created using funds from at least one of a down payment, a life insurance payout, a disability insurance payout, a part of a pension payout, a part of an annuity payout, and a monetary instrument provisioned for the purpose of the creation of the fund.

14. A method as defined in claim 1, wherein the fund is created over time using at least in part funds from installment payments from at least one of a dedicated installment payments for the creation of the fund, a part of pension installment payments, a part of annuity installment payments, a part of life insurance periodic payments, and a part of other insurance periodic payments.

15. A method as defined in claim 1, wherein the fund is perpetual in nature by being configured to generate sufficient investment proceeds to (i) finance repeatedly costs relating to administration, storage, maintenance, insurance and other services relating to the legal entity and the dedicated data body and to (ii) maintain real value of the fund over long periods through reinvestment.

16. A method as defined in claim 15, further comprising using external income derived from monetization of the dedicated data body to grow the fund, the monetization comprising third party payment for access and interaction with the dedicated data body and related services.

17. A method as defined in claim 16, wherein the legal entity creating step, the fund creating step, and the insurance policy establishing step are performed by a guardian, and wherein the income from the fund above that required for reinvestment to maintain real value, is distributed by the guardian to the insurance provider for insurance premiums, data service providers for the data services and to the guardian for administrative fees.

18. A method as defined in claim 17, wherein the funds distributed to the insurance provider are at least partially for compensating the insurance provider for providing insurance that insures against partial or total loss of the data.

19. A method as defined in claim 17, wherein the funds distributed to the insurance provider are at least partially for compensating the insurance provider for providing insurance that insures against partial or total loss of accessibility to the data.

20. A method as defined in claim 17, wherein the funds distributed to the insurance provider are at least partially for compensating the insurance provider for providing insurance that insures against partial or total failure of the data service provider to convert older data formats to newer data formats.

21. A method as defined in claim 17, wherein the funds distributed to the insurance provider are at least partially for compensating the insurance provider for providing insurance that insures against inability of the original owner to complete creation of the perpetual fund.

22. A method as defined in claim 1, wherein the beneficiary of the insurance policies associated with the legal entity and the dedicated data body is the legal entity, and the proceeds of an insurance payout are used to perform at least one of the following: (1) repair the dedicated data body, (2) enhance the data services, (3) augment the legal entity, (4) and increase the associated fund, as determined by one of the original owner and the guardian.

23. A method as defined in claim 1, wherein the fund associated with one legal entity and dedicated body finances additional dedicated data bodies and their associated data services.

24. A method comprising
creating a legal entity that is associated with an original owner, a dedicated data body and data services for the dedicated data body;
establishing an insurance policy, associated with the legal entity, which is issued by an insurance provider.

25. A method as defined in claim 24, wherein the legal entity creating step and the insurance policy establishing step are performed by a guardian, wherein the legal entity is managed by the guardian, and wherein the guardian functions as agent for the original owner and the legal entity, with information technology expertise and group purchasing power, negotiating with and engaging data service providers and insurance providers to service and protect the dedicated data body and related services.

26. A method as defined in claim 25, wherein the funds distributed to the insurance provider are at least partially for compensating the insurance provider for providing insurance that insures against death or financial disability of the original owner, and the payout of which is used to create a perpetual fund to finance the continued maintenance of the dedicated data body and associated services.

27. In a system comprising a dedicated data body stored in computer-readable media, data services providers that service the dedicated data body, an insurance provider that provides insurance with respect to the dedicated data body and maintenance thereof, a fund manager that manages a perpetual fund that finances the services of the data services providers and the insurance provider, and a guardian that engages and oversees the data service providers, the insurance provider, and the fund manager, a method, performed by the guardian, comprising:
managing a legal entity that owns the perpetual fund, including using the earnings of the perpetual fund to make repeated payments to the data services providers and the insurance provider, the payments to the data services providers being at least partially for compensating the data services providers for storing, maintaining and expanding the dedicated data body and for ensuring that the data body remains continuously accessible by computing devices over time, the payments to the insurance provider being at least partially for compensating the insurance provider for providing insurance that insures against partial or total loss of the data and against partial or total loss of accessibility to the data, the perpetual fund being configured to generate sufficient investment proceeds to (i) make the repeated payments to the insurance provider and the data services provider the data management services and other services and to (ii) maintain the real value of the perpetual fund over long periods through reinvestment;
wherein the dedicated data body comprises data that is dedicated to a specific person;
wherein the dedicated data body, the legal entity and the perpetual fund are owned by the person during the lifetime of the person;
wherein the dedicated data body, associated legal entity and associated fund are controlled by the guardian after the death of the person; and
wherein the dedicated data body is stored in machine-readable storage media and being accessible by computing devices via global networks to generate output for presentation to a user.

28. A method as defined in claim 27, wherein the perpetual fund is created by linking the creation thereof to the creation of pension or annuity funds during a owner's working years, wherein portion of the periodic payments to the pension or annuity funds is allocated to the creation of the perpetual fund.

29. In a system comprising a dedicated data body stored in computer-readable media, data services providers that service the dedicated data body, and a virtual life manager that engages and oversees the services providers; a method, performed by the virtual life manager, comprising:
receiving payments from the data owner; and
deducting, from the payments, fees for services of the virtual life manager; and
making repeated payments to the data services providers, the payments to the data services providers being at least partially for compensating the data services providers for storing and maintaining the dedicated data body, for ensuring that the data body remains continuously accessible by computing devices over time and for providing services and applications for the growth and use of the data body;
wherein the dedicated data body comprises data that is dedicated to a specific social or commercial entity, the dedicated data body being stored in machine-readable storage media and being accessible by computing devices via global networks.
